(19) United States
(12) Patent Application Publication
(10) Pub. No.: US 2016/0301272 A1
(43) Pub. Date: Oct. 13, 2016

(54) STATOR FOR ROTARY ELECTRIC MACHINE

(71) Applicants: TOYOTA JIDOSHA KABUSHIKI KAISHA; AISIN SEIKI KABUSHIKI KAISHA

(72) Inventors: Kentarou HARUNO, Toyota-shi (JP); Hiroshi HOSHINA, Toyota-shi (JP); Tatsuya NAKAHO, Toyota-shi (JP); Isao KATO, Toyoake-shi (JP)

(73) Assignees: TOYOTA JIDOSHA KABUSHIKI KAISHA, Toyota-shi, Aichi-ken (JP); AISIN SEIKI KABUSHIKI KAISHA, Kariya-shi, Aichi-ken (JP)

(21) Appl. No.: 15/101,131

(22) PCT Filed: Nov. 14, 2014
(86) PCT No.: PCT/JP2014/005748

§ 371 Date: Jun. 2, 2016

(30) Foreign Application Priority Data
Dec. 4, 2013 (JP) 2013-250759

(51) Int. Cl. H02K 3/28; H02K 3/52; H02K 1/12

(52) U.S. Cl. CPC H02K 3/28; H02K 1/12; H02K 3/522

(57) ABSTRACT

According to the present invention, a stator for a rotary electric machine includes a stator core, coils of three phases formed of flat-type wire coils wound on the stator core by concentrated winding, neutral point bus bars which are connected to coil terminating ends respectively extending from innermost circumferences of the coils of three phases, and a neutral point formed by joining the neutral point bus bars to each other. The neutral point is formed by joining terminating ends of the three-phase neutral point bus bars to each other in a state in which the terminating ends are arranged adjacent to each other in the circumferential direction.

### TECHNICAL FIELD

The present invention relates to a stator for use in a rotary electric machine, and particularly to a structure of neutral point bus bars joined to each other to thereby form a neutral point.

### BACKGROUND ART

A stator of a rotary electric machine generally includes a stator core having a plurality of teeth, and coils of three phases wound around the teeth. Known types of coil windings include concentrated winding for winding a coil between two adjacent slots, and distributed winding for winding a coil between two slots which are apart from each other by at least 3 slots. JP 2013-165566 A and JP 2013-5541 A disclose a stator for a rotary electric machine including wire coils, which are flat-type wires, wound by concentrated winding.

JP 2013-165566 A discloses a stator for a rotary electric machine including a first concentrated winding coil and a second concentrated winding coil arranged alternately in the circumferential direction. The first concentrated winding coil includes a neutral point connection side terminal located on the inner diameter side and an external connection side terminal located on the outer diameter side, and the second concentrated winding coil includes a neutral point connection side terminal located on the outer diameter side and an external connection side terminal located on the inner diameter side. With such a structure, as it is necessary to join the neutral point connection side terminal located on the inner diameter side and the neutral point connection side terminal located on the outer diameter side in order to form the neutral point, the length of the terminals (coils) is increased by joining the neutral point connection side terminals on the inner diameter side and the outer diameter side together, leading to a problem of an increase in loss, such as copper loss.

JP 2013-5541 A discloses a technology of, in order to form the neutral point, extending a bus bar drawn from the innermost circumference of a coil of one phase in the circumferential direction to join the bus bar drawn from the innermost circumference of a coil of another phase. In JP 2013-5541 A, however, the bus bar of another phase and the bus bar of one phase are made to be adjacent to each other in the radial direction for joining. In this case, as the thickness in the radial direction is increased, the neutral point easily projects radially inward with respect to the innermost circumference of the coil. As the coil is generally fixed by molding with a mold resin after winding, there is a possibility that the neutral point which projects radially inward interferes with a mold die. Further, in JP 2013-5541 A, the bus bar of one phase having an increased length by being drawn in the circumferential direction causes problems including an increased loss such as copper loss or an increased physical constitution. Also, as the bus bar with an increased length has a correspondingly poor shape retention property, projection of the neutral point radially inward and so on, as described above, is more likely to occur.

It is therefore an advantage of the present invention to provide a stator including neutral point bus bars joined to each other to form a neutral point, with a further reduced length, and having a structure that can more reliably prevent projection of the neutral point radially inward.

### SUMMARY OF INVENTION

In accordance with an aspect of the invention, a stator for a rotary electric machine includes a stator core; coils of three phases formed of flat-type wire coils wound on the stator core by concentrated winding; neutral point bus bars connected to respective coil terminating ends and extending from innermost circumferences of the coils of three phases, respectively; and a neutral point formed by joining the neutral point bus bars of the coils of three phases to each other, and the neutral point is formed by joining terminating ends of the three-phase neutral point bus bars to each other in a state in which the terminating ends of the three-phase neutral point bus bars are arranged adjacent to each other in the circumferential direction.

In accordance with a preferred aspect, the neutral point is formed radially outward with respect to the innermost circumference of the coil. In accordance with another preferred aspect, the neutral point bus bar is a flat-type wire having a rectangular cross sectional shape, and when the neutral point bus bar is drawn in the axial direction of the rotary electric machine, the cross sectional shape has a thickness dimension which is a length in the radial direction of the rotary electric machine, and the thickness dimension is substantially the same as or greater than a width dimension which is a length in the circumferential direction of the rotary electric machine.

In accordance with still another preferred aspect, of the neutral point bus bars of three phases, the neutral point bus bar of one phase located in the middle is shifted radially outward with respect to the innermost circumference of the coil and thereafter extends axially outward, and the neutral point bus bars of the remaining two phases are drawn in the circumferential direction and thereafter extend axially outward so as to reach respective side surfaces in the circumferential direction of the terminating end of the neutral point bus bar of the one phase located in the middle.

According to the present invention, as the neutral point is formed by joining the neutral point bus bars of the three phases in a state in which the terminating ends of the bus bars are arranged adjacent to the each other in the circumferential direction, it is possible to further reduce the lengths of the neutral point bus bars. It is also possible to more reliably prevent projection of the neutral point radially inward.

### BRIEF DESCRIPTION OF DRAWINGS

FIG. 1 is a top view of a stator according to an embodiment of the present invention.

FIG. 2 is an enlarged view of a principal portion of the stator.

FIG. 3 is a cross sectional view taken along line B-B of FIG. 2.

FIG. 4 is a view seen from direction A of FIG. 1.

FIG. 5 is a view showing only neutral point bus bars.

FIG. 6 is a view illustrating another structure of the neutral point bus bar.

FIG. 7 is a view for explaining a difference in the height of the neutral point caused by different amount of shift in the radial direction.

FIG. 8 is an enlarged view of a principal portion of a conventional stator.

### DESCRIPTION OF EMBODIMENTS

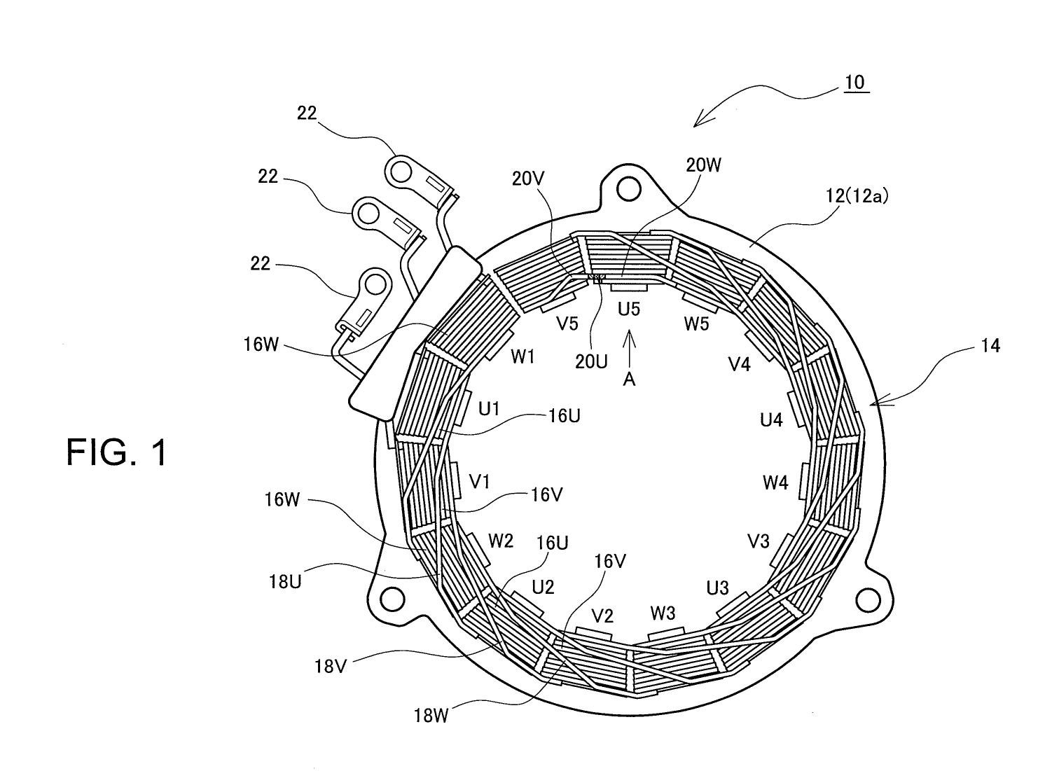

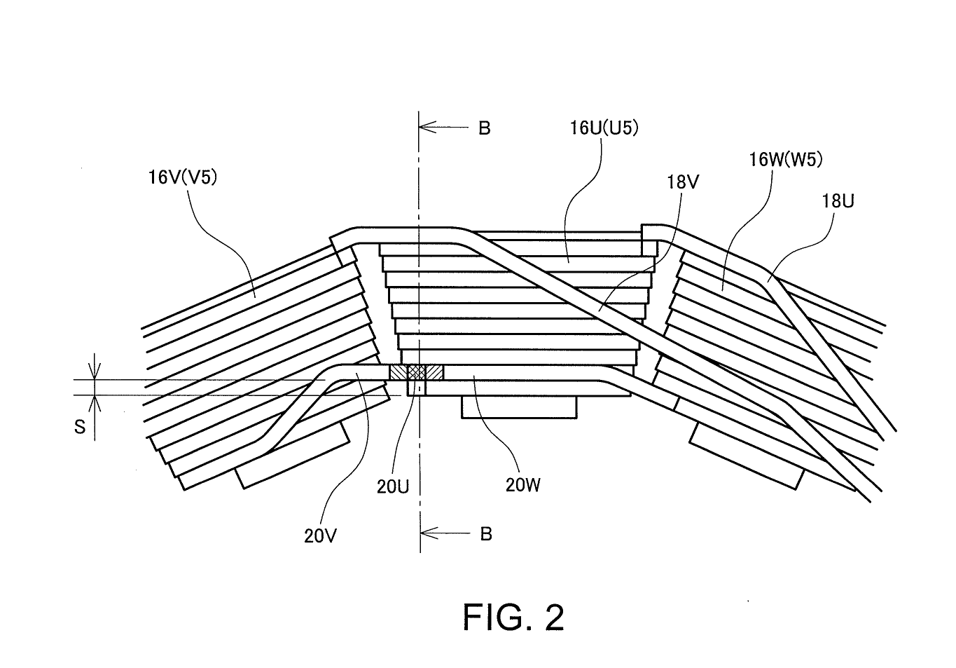

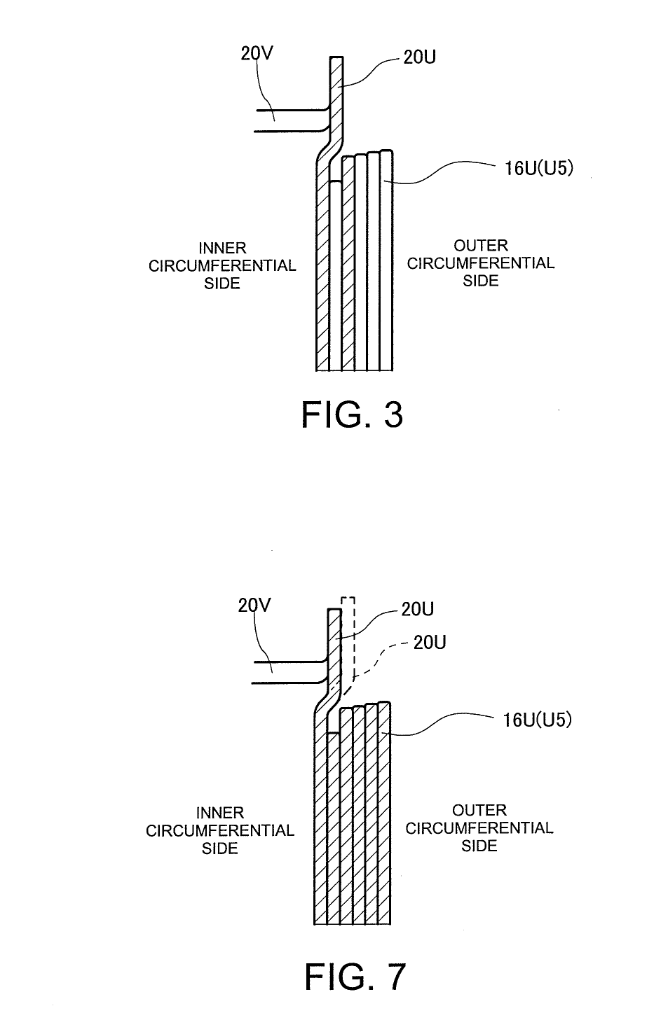

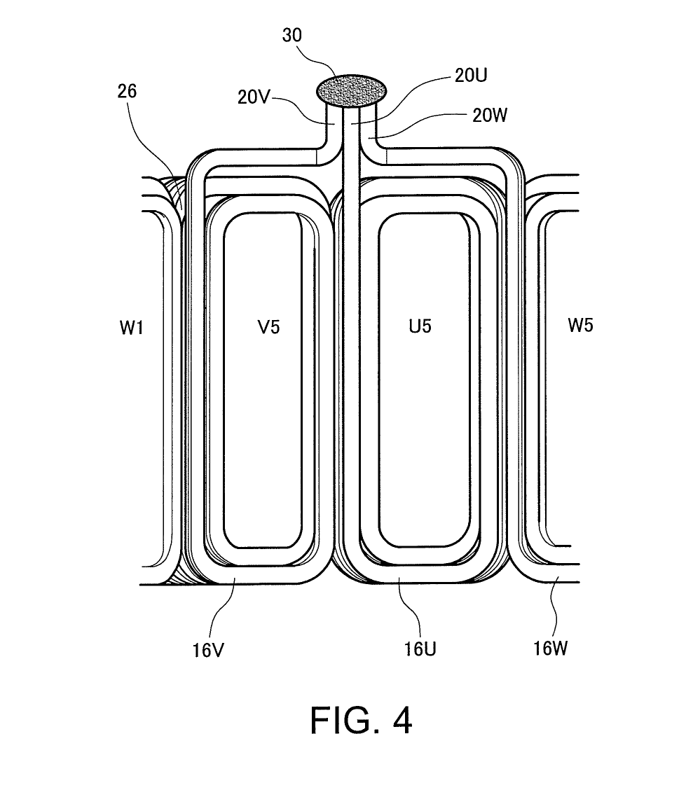

Preferred embodiments of the present invention will be described with reference to the drawings. FIG. 1 is a top view of a stator 10 for use in a rotary electric machine according to an embodiment of the present invention. FIG. 2 is an enlarged view of a principal portion of the stator 10; FIG. 3 is a cross sectional view taken along line B-B of FIG. 2; and FIG. 4 is a view seen from direction A of FIG. 1. In FIG. 2, for ease of understanding, terminating ends of neutral point bus bars 20U, 20W, and 20V, which will be described below, are hatched, and in FIGS. 3 and 4, only the coils are shown while the stator core is not shown.

As illustrated in FIG. 1, the stator 10 includes a stator core 12 formed of a layered electromagnetic steel sheet, a dust core, and so on, and a stator coil 14 composed of coils 16W, 16U, and 16V of three phases (which will hereinafter be referred to simply as “coil 16” when it is not necessary to discriminate among the three phases, and the same will similarly apply to other components). The stator core 12 includes a back core 12a having a substantially cylindrical shape and a plurality of teeth (which cannot be seen due to the coil 16 in the figure) arranged at equal intervals in the circumferential direction along the inner circumference of the back core 12a. A coil wire is wound around each tooth via an insulating member (not shown) which is provided to electrically insulate the stator coil 14 from the stator core 12.

The stator coil 14 according to the present embodiment is composed of wire coils made of flat-type wire by concentrated winding. Enameling is applied to a surface of the flat-type wire so as to ensure insulation between flat-type wires adjacent to each other. The stator coil 14 includes the coils 16 of three phases; that is, a W-phase coil 16W, a U-phase coil 16U, and a V-phase coil 16V, and each phase coil 16 is composed of one or more (five in the illustrated example) single coils W1 to W5, U1 to U5, and V1 to V5. Each of the single coils W1 to W5, U1 to U5, and V1 to V5 is formed of a wire coil made of flat-type wire wound around a single tooth. In the following description, the single coils W1 to W5, U1 to U5, and V1 to V5 will be referred to W-phase single coils W1 to W5, U-phase single coils U1 to U5, and V-phase single coils V1 to V5 in accordance with the corresponding phases.

A plurality of single coils are set with respect to the stator core 12 such that the W-phase single coils W1 to W5, the U-phase single coils U1 to U5, and the V-phase single coils V1 to V5 are sequentially arranged in this order of phase repeatedly in the circumferential direction of the stator core 12. A single coil of each phase is connected, via an inter-phase-connecting bus bar 18 which is formed by extending an end of the single coil, to another in-phase single coil wound around another tooth. The interphase-connecting bus bar 18 is formed by extending an end of each phase single coil on the inner circumferential side, and is connected to an end of another in-phase single coil on the outer circumferential side.

Each of the phase coils 16 formed of a plurality of in-phase single coils W1 to W5, U1 to U5, and V1 to V5 that are coupled with each other has a starting end on the outermost circumference of the coil and, and an input terminal 22 is coupled with the starting end. Each phase coil 16 also has a terminating end located on the innermost circumference of the coil. The terminating ends of the respective phase coils 16 are extended to form the neutral point bus bars 20W, 20U, and 20V, respectively. The neutral point bus bars 20W, 20U, and 20V of three phases are converged into one location and joined with each other to thereby form a neutral point.

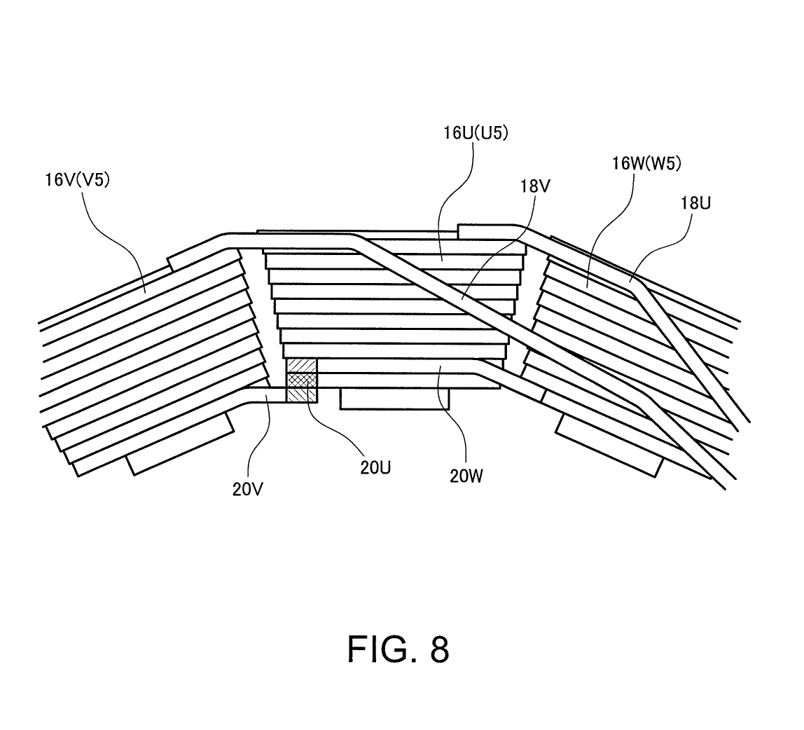

All of the neutral point bus bars 20 of three phases are drawn upward of the coil end from the innermost circumference of the coil 16 and are thereafter converged and joined together to form a neutral point 30. Conventionally, the terminating ends (joining portions) of these neutral point bus bars 20W, 20U, 20V are joined in a state in which the joining portions are arranged in the radial direction of the rotary electric machine. For example, as illustrated in FIG. 8, the U-phase neutral point bus bar 20U located in the center is extended straight upward (axially outward), and the W-phase and V-phase neutral point bus bars 20W and 20V located on the respective sides are extended in the circumferential direction. Then, these neutral point bus bars 20U, 20W, and 20V of three phases are joined to each other in a state in which the joining portions thereof are arranged in the circumferential direction, thereby forming the neutral point. However, as illustrated in FIG. 8, when the joining portions of the neutral point bus bars 20U, 20W, and 20V of three phases are arranged in the circumferential direction, the V-phase neutral point bus bar 20V located radially inward with respect to the U-phase neutral point bus bar 20U projects radially inward with respect to the innermost circumference of the coil 16U.

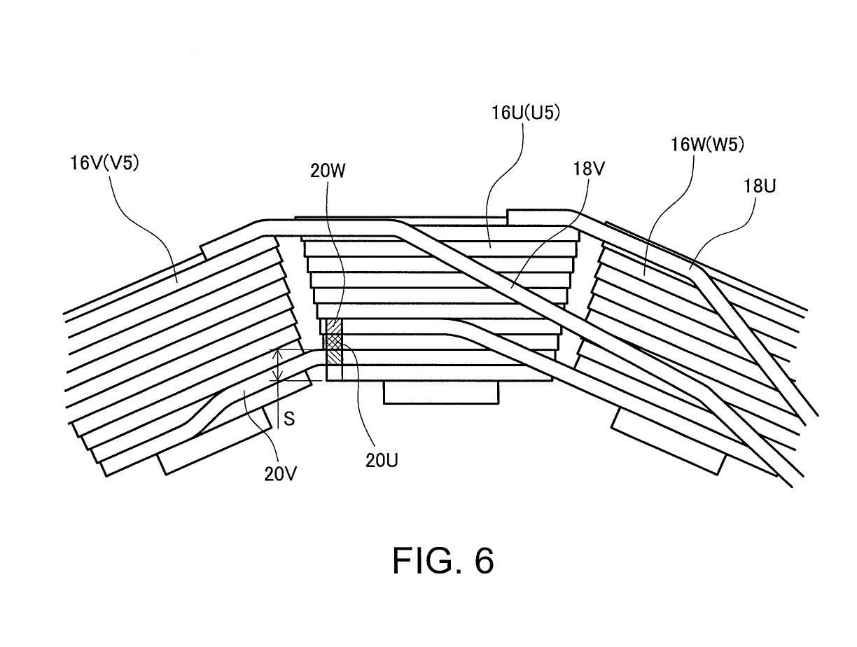

In order to avoid such a problem, it can be considered that, as illustrated in FIG. 6, the U-phase neutral point bus bar 20U is drawn upward and thereafter shifted radially outward. More specifically, it can be considered that the U-phase neutral point bus bar 20U is drawn straight upward and thereafter bent radially outward, and is further bent upward again. By shifting the U-phase neutral point bus bar 20U radially outward by an amount corresponding to two coil windings in such a structure, it is possible to prevent the V-phase neutral point bus bar 20V from projecting radially inward.

However, the U-phase neutral point bus bar 20U, when shifted in the radial direction (extended in the radial direction) by an amount corresponding to approximately two coil windings, resultantly has a correspondingly increased length, which causes disadvantages of an increased loss and increased costs by the extended bus bar 20. Further, as will be detailed below, an increase in the amount of movement of the U-phase neutral point bus bar 20U in the radial direction (which will be hereinafter referred to as “a radial direction shift amount S” makes it necessary to raise the position of the terminating end of the U-phase neutral point bus bar 20U (the position of the neutral point), causing a problem of an increase in the physical constitution of the rotary electric machine.

According to the present embodiment, in order to avoid the above disadvantages, the joining portions of the three-phase neutral point bus bars 20U, 20W, and 20V are arranged adjacent to each other in the circumferential direction and jointed to each other in this state, to thereby form the neutral point, as illustrated in FIGS. 2 to 4.

As illustrated in FIGS. 2 and 3, according to the present embodiment, the U-phase neutral point bus bar 20U located in the center of the three-phase bus bars is drawn straight axially outward (upward in FIG. 3) from the terminating end of the U-phase coil 16U, and is thereafter bent radially outward at a position which is higher than the upper end of the coil. Then, after being shifted radially outward by an amount corresponding to about one coil winding, the U-phase neutral point bus bar 20U is again bent axially outward.

The V-phase neutral point bus bar 20V located adjacent to the U-phase neutral point bus bar 20U on the left side in the circumferential direction is drawn axially outward from the terminating end of the V-phase coil 16V, and is thereafter bent outward in the radial direction at a position which is higher than the upper end of the coil and extended toward the U-phase neutral point bus bar 20U. Further, the V-phase neutral point bus bar 20V is bent axially outward near the U-phase neutral point bus bar 20U to be located contiguous to the side surface of the U-phase neutral point bus bar 20U in the circumferential direction.

Similarly, the W-phase neutral point bus bar 20W located adjacent to the U-phase neutral point bus bar 20U on the right side in the circumferential direction is also drawn axially outward from the terminating end of the W-phase coil 16W, and is thereafter bent outward in the radial direction at a position which is higher than the upper end of the coil and extended toward the U-phase neutral point bus bar 20U. Further, the W-phase neutral point bus bar 20W is bent axially outward near the U-phase neutral point bus bar 20U to be located contiguous to the side surface of the U-phase neutral point bus bar 20U in the circumferential direction.

The joining portions of the three-phase neutral point bus bars 20U, 20W, and 20V which are arranged adjacent to each other in the circumferential direction are joined to each other to thereby form the neutral point. The configuration of the joining portions of the bus bars 20 of three phases, which are arranged in the circumferential direction as described above, significantly reduces the dimension of the neutral point 30 in the radial direction, which makes it unlikely that the neutral point 30 projects inward with respect to the innermost circumference of the stator coil 14.

The configuration of the joining portions of the bus bars 20 of three phases, which are arranged in the circumferential direction, can also reduce the shift amount S of the U-phase neutral point bus bar 20U in the radial direction to a relatively small level. Specifically, when the joining portions of the bus bars of three phases are arranged in the radial direction as illustrated in FIG. 6, the neutral point bus bar 20V of V-phase is located inward in the radial direction with respect to the U-phase neutral point bus bar 20U. Therefore, in order to reliably prevent projection of the neutral point inward, it is necessary to set the shift amount S of the U-phase neutral point bus bar 20U in the radial direction to be greater than the shift amount corresponding to one coil winding. According to the present embodiment, on the other hand, as neither the bus bars 20V nor 20W of phases other than U phase are present on the radially inward side with respect to the U-phase neutral point bus bar 20U, the shift amount S in the radial direction may be smaller than that corresponding to one coil winding. As such, with the technology of the present embodiment, it is possible to reduce the length of the U-phase neutral point bus bar 20U as compared to the technology illustrated in FIG. 6.

The increase in the shift amount S in the radial direction also causes a rise in the position of the joining portion of the U-phase neutral point bus bar 20U, in order to avoid interface between the U-phase neutral point bus bar 20U and the coil end. This will be described with reference to FIG. 7, which shows a difference in the height of the neutral point 30 caused by different shift amounts S in the radial direction.

In general, the height of the U-phase single coil U5 wound around the tooth at the upper end is relatively lower on the innermost circumference side thereof but is relatively higher on the radially outward side thereof. Accordingly, when the shift amount S in the radial direction is great (as in the case of the bus bar 20U shown by a dashed line in FIG. 7), it is necessary to make the height of the U-phase neutral point bus bar 20U extending in the radial direction relatively high, in order to avoid interference of the U-phase neutral point bus bar 20U with the upper end of the coil. This resultantly makes the final position of the neutral point 30 (the position of the terminating end of the bus bar 20U) relatively high. On the other hand, when the shift amount S in the radial direction is small as in the present embodiment, it is possible to suppress the height of the U-phase neutral point bus bar 20U extending in the radial direction to a relatively low level, thereby lowering the height of the neutral point 30. This results in advantages of a reduction in the whole physical constitution of the rotary electric machine and also a reduction of the amount of coil to be used, which can lead to cost reduction.

Further, according to the present embodiment, the W-phase and V-phase neutral point bus bars 20W and 20V are molded so as not to reach the U-phase neutral point bus bar 20U prior to joining. If the neutral point bus bars 20W and 20V are molded to reach the U-phase neutral point bus bar 20U before joining, no binding force is generated in the neutral point bus bars 20U, 20W, and 20V, which causes a disadvantage that these bus bars 20U, 20W, and 20V are easily inclined in the radial or circumferential direction. If the neutral point bus bars 20U, 20W, and 20V are inclined radially inward, the neutral point 30 projects radially inward with respect to the innermost circumference of the coil. If the neutral point bus bars 20U, 20W, and 20V are inclined in the circumferential direction, it is not possible to maintain a sufficient gap between different phases. In particular, as there is a great potential difference between the W-phase single coil W1 having an input end and the V-phase single coil V5 having the neutral point bus bar 20V, it is necessary to secure a sufficient gap between these single coils W1 and V5 located on both ends; that is, a sufficient phase gap 26 (see FIG. 4). In the conventional structure, however, the neutral point bus bars 20V may be inclined in the circumferential direction, which may result in failure to secure a sufficient phase gap 26.

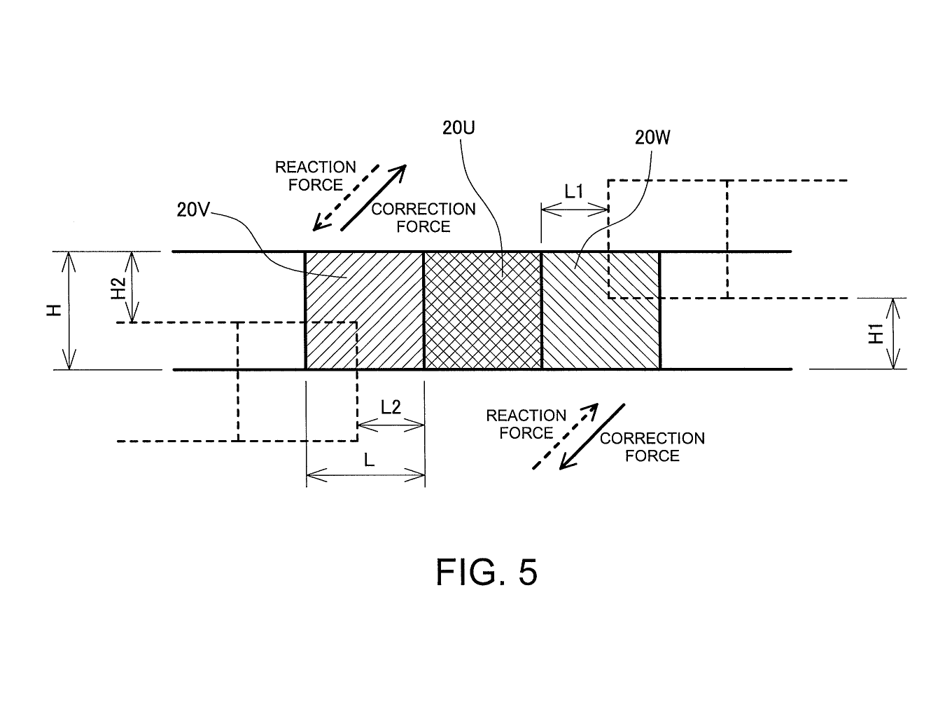

In order to overcome the above disadvantages, according to the present embodiment, the W-phase and V-phase neutral point bus bars 20W and 20V are molded in a special manner, which will be described with reference to FIG. 5 illustrating only the neutral point bus bars 20U, 20W, and 20V of three phases. In FIG. 5, dashed lines indicate the shapes of the V-phase and W-phase neutral point bus bars 20V and 20W after bending molding of the neutral point bus bars 20 and before joining of the neutral point bus bars 20, and solid lines indicate the shape of the three-phase neutral point bus bar 20U, 20V, and 20W after being joined to each other.

The neutral point bus bars 20 are molded into a desired shape by bending molding before joining. According to the present embodiment, as illustrated in FIG. 5, after this bending molding and before joining, the V-phase neutral point bus bar 20V is molded such that the terminating end (joining portion) thereof is located apart from the joining portion of the U-phase neutral point bus bar 20U toward the V-phase side in the circumferential direction (toward the base end of V-phase neutral point bus bar 20V) and toward the radially inward side. Similarly, the W-phase neutral point bus bar 20W is molded, after bending molding and before joining, such that the terminating end (joining portion) thereof is located apart from the joining portion of the U-phase neutral point bus bar 20U toward the W-phase side in the circumferential direction (toward the base end of W-phase neutral point bus bar 20W) and toward the radially outward side. In other words, in the present embodiment, both the V-phase and W-phase neutral point bus bars 20V and 20W are molded into a shape having a joining portion which cannot reach the joining portion of the U-phase neutral point bus bar 20U before joining.

The distances L2 and H2 between the joining portion of the U-phase neutral point bus bar 20U and the joining portion of the V-phase neutral point bus bar 20V are determined such that the neutral point bus bar 20V is not plastically deformed by correction during joining, in consideration of the gap amounts between the coil windings and between the coil 16 and the insulating member, residual stress of the joining (welding) portion, and so on.

According to the present embodiment, with the V-phase neutral point bus bar 20V being pulled toward the U-phase neutral point bus bar 20U for correction and thus being elastically deformed, the joining portion of the V-phase neutral point bus bar 20V and the joining portion of the U-phase neutral point bus bar 20U are joined to each other. In this case, a reaction force resulting from the elastic restoring force is generated on the joining portion of the U-phase neutral point bus bar 20U (and, by extension, the whole U-phase neutral point bus bar 20U). This reaction force works toward the direction of the joining portion of the V-phase neutral point bus bar 20V; that is, toward the V-phase side in the circumferential direction and toward radially inward side. Consequently, in a state in which only the joining portion of the U-phase neutral point bus bar 20U and the joining portion of the V-phase neutral point bus bar 20V are joined, the U-phase neutral point bus bar 20U is easily inclined toward the V-phase coil 16V side and radially inward by the reaction force.

In the present embodiment, the joining portion of this U-phase neutral point bus bar 20U is further joined to the joining portion of the W-phase neutral point bus bar 20W. The distances L1 and H1 between the joining portion of this U-phase neutral point bus bar 20U and the joining portion of the W-phase neutral point bus bar 20W are determined such that the neutral point bus bar 20W is not plastically deformed by correction during joining, in consideration of the gap amounts between the coils and between the coil 16 and the insulating member, residual stress of the joining (welding) portion, and so on. In addition to consideration of the plastic deformation described above, the distances L1 and L1 between the joining portion of the U-phase neutral point bus bar 20U and the joining portion of the W-phase neutral point bus bar 20W are also set such that the reaction force generated in the joining portion of the U-phase neutral point bus bar 20U due to the joining to the joining portion of the W-phase neutral point bus bar 20W is balanced with the reaction force generated in the joining portion of the U-phase neutral point bus bar 20U due to the joining to the V-phase neutral point bus bar 20V.

Then, by correcting the W-phase neutral point bus bar 20W and joining the joining portion of this W-phase neutral point bus bar 20W to the joining portion of the U-phase neutral point bus bar 20U, both the reaction force toward the V-phase side in the circumferential direction and the radially inward side and the reaction force toward the W-phase side in the circumferential direction and the radially outward side act on the joining portion of the U-phase neutral point bus bar 20U. With the forces in the opposite directions and with substantially the same magnitudes acting on the joining portion of the U-phase neutral point bus bar 20U in this manner, the position of the joining portion of the U-phase neutral point bus bar 20U is stabilized, so that inclination of the U-phase neutral point bus bar 20U in the radial direction and in the circumferential direction can be advantageously prevented. This results in effective prevention of the neutral point coming into contact with the molding die, so that a sufficient phase gap 26 can be ensured more reliably.

Further, according to the present embodiment, the side surfaces of the neutral point bus bars 20U, 20W, and 20V in the circumferential direction are joined to each other as described above. The larger the area of this side surface in the circumferential direction; i.e., the larger the area of the portion for joining, the greater the joining force. According to the present embodiment, the neutral point bus bars 20U, 20W, and 20V are configured such that, when the neutral point bus bars 20U, 20W, and 20V are drawn in the axial direction of the rotary electric machine, the thickness dimension H, which is the length in the radial direction of the rotary electric machine, is substantially the same as the width dimension L, which is the length in the circumferential direction of the rotary electric machine, or is greater than the width dimension L (H>=L). With this structure, separation of the joining portions of the neutral point bus bars 20U, 20W, and 20V can be prevented more reliably.

As described above, according to the present embodiment, the configuration of the three-phase neutral point bus bars 20U, 20W, and 20V, which are arranged adjacent to each other in the circumferential direction and joined, prevents projection of the neutral point bus bars 20 radially inward, so that protrusion of the neutral point toward the inner circumferential side with respect to the innermost circumference of the coil 16 can be effectively prevented. Such a protrusion toward the inner circumferential side can be more effectively prevented by shifting the U-phase neutral point bus bar 20U radially outward. Also, according to the present embodiment, as the V-phase and W-phase neutral point bus bars 20V and 20W are molded such that they cannot reach the U-phase neutral point bus bar 20U before joining, the inclination of the neutral point bus bars 20 radially inward and in the circumferential direction can be prevented with significant effectiveness.

All of the structures described above are only examples, and, so long as the three-phase neutral point bus bars 20U, 20W, and 20V are arranged adjacent to each other in the circumferential direction and joined, other structures may be modified. For example, while in the above example, the U-phase neutral point bus bar 20U which is located in the middle in the circumferential direction is radially shifted, such a shift in the radial direction may be omitted. Also, while in the above example, the V-phase and W-phase neutral point bus bars 20V and 20W are molded such that they cannot reach the U-phase neutral point bus bar 20U before joining, this structure may also be omitted.

1. A stator for a rotary electric machine, the stator comprising:
a stator core;
coils of three phases formed of flat-type wire coils wound on the stator core by concentrated winding;
neutral point bus bars connected to respective coil terminating ends and extending from innermost circumferences of the coils of three phases, respectively; and
a neutral point formed by joining the neutral point bus bars of the coils of three phases to each other,
wherein the neutral point is formed by joining terminating ends of the three-phase neutral point bus bars to each other, the terminating ends of the three-phase neutral point bus bars being arranged adjacent to each other in the circumferential direction.

2. The stator for a rotary electric machine according to claim 1, wherein the neutral point is formed radially outward with respect to the innermost circumference of the coil.

3. The stator for a rotary electric machine according to claim 1, wherein the neutral point bus bar is a flat-type wire having a rectangular cross sectional shape, and
when the neutral point bus bar is drawn in the axial direction of the rotary electric machine, the cross sectional shape has a thickness dimension which is a length in the radial direction of the rotary electric machine, the thickness dimension being substantially the same as or greater than a width dimension which is a length in the circumferential direction of the rotary electric machine.

4. The stator for a rotary electric machine according to claim 2, wherein the neutral point bus bar is a flat-type wire having a rectangular cross sectional shape, and
when the neutral point bus bar is drawn in the axial direction of the rotary electric machine, the cross sectional shape has a thickness dimension which is a length in the radial direction of the rotary electric machine, the thickness dimension being substantially the same as or greater than a width dimension which is a length in the circumferential direction of the rotary electric machine.

5. The stator for a rotary electric machine according to claim 1, wherein of the neutral point bus bars of three phases, the neutral point bus bar of one phase located in the middle is shifted radially outward with respect to the innermost circumference of the coil and thereafter extends axially outward, and
the neutral point bus bars of the remaining two phases are drawn in the circumferential direction and thereafter extend axially outward so as to reach respective side surfaces in the circumferential direction of the terminating end of the neutral point bus bar of the one phase located in the middle.

6. The stator for a rotary electric machine according to claim 2, wherein of the neutral point bus bars of three phases, the neutral point bus bar of one phase located in the middle is shifted radially outward with respect to the innermost circumference of the coil and thereafter extends axially outward, and
the neutral point bus bars of the remaining two phases are drawn in the circumferential direction and thereafter extend axially outward so as to reach respective side surfaces in the circumferential direction of the terminating end of the neutral point bus bar of the one phase located in the middle.

7. The stator for a rotary electric machine according to claim 3, wherein of the neutral point bus bars of three phases, the neutral point bus bar of one phase located in the middle is shifted radially outward with respect to the innermost circumference of the coil and thereafter extends axially outward, and
the neutral point bus bars of the remaining two phases are drawn in the circumferential direction and thereafter extend axially outward so as to reach respective side surfaces in the circumferential direction of the terminating end of the neutral point bus bar of the one phase located in the middle.

8. The stator for a rotary electric machine according to claim 4, wherein of the neutral point bus bars of three phases, the neutral point bus bar of one phase located in the middle is shifted radially outward with respect to the innermost circumference of the coil and thereafter extends axially outward, and
the neutral point bus bars of the remaining two phases are drawn in the circumferential direction and thereafter extend axially outward so as to reach respective side surfaces in the circumferential direction of the terminating end of the neutral point bus bar of the one phase located in the middle.
